(19) United States
(12) Patent Application Publication
(10) Pub. No.: US 2015/0260502 A1
(43) Pub. Date: Sep. 17, 2015

(54) VEHICLE DETECTION SYSTEM

(71) Applicant: Omnet IP Pty Ltd, Carlton VIC (AU)

(72) Inventor: Mike Hamilton, Boronia VIC (AU)

(21) Appl. No.: 14/409,373

(22) PCT Filed: May 17, 2013
(86) PCT No.: PCT/AU2013/000511

§ 371 Date: Dec. 18, 2014

(30) Foreign Application Priority Data
May 17, 2012 (AU) 2012902023

(51) Int. Cl. G01B 7/14; B61L 25/04

(52) U.S. Cl. CPC G01B 7/14; B61L 25/046

(57) ABSTRACT

There is disclosed a method of detecting the presence of a vehicle travelling along a path comprising the steps of; positioning a predetermined number of sensor elements long a predetermined portion of the path at predetermined intervals, each sensor element being configured to take a reading of a magnetic field present in their immediate proximity and to transmit a signal in accordance with said reading; receiving one or more transmitted signals from one or more of the predetermined number of sensor elements; processing the received transmitted signals to identify an active sensor element that transmitted the signal from the predetermined number of sensor elements; comparing the number of active sensor elements against a number of live sensor elements to determine whether a vehicle is travelling along the path; and activating a warning system upon determining that a vehicle is travelling along the path.

### RELATED APPLICATIONS

This application claims priority from Australian Provisional Patent Application No. 2012902023, filed 17 May 2012, the entire contents of which are incorporated herein by reference.

### FIELD OF INVENTION

This present invention relates to a system for detecting the presence of a vehicle moving along a dedicated path, and in particular, to a system for detecting the presence and direction of a train or locomotive moving along a rail network.

### BACKGROUND OF THE INVENTION

Vehicles, such as locomotives or trains, perform an important function in most societies for transporting, en masse, materials and people over short and long distances. In this regard, locomotives or trains have a particular advantage over other transport methods, such as road transport systems, as they operate on dedicated tracks which can be laid across vast areas of land, to ensure that the locomotives do not travel along roads that are commonly used by general road traffic. This can significantly reduce traffic congestion in populated areas.

However, one common problem with train or locomotive networks is the fact that the networks often have to cross roads that are used by general road vehicles, such as cars, trucks and the like. Unfortunately, many persons, including pedestrians and drivers and occupants of road vehicles are killed or injured each year due to collisions with moving locomotives or trains at crossings where such rail vehicles cross public and private roads. In many instances, this may be due to the person being unaware of the presence of the train or locomotive on the rail track until it is too late to avoid collision.

As trains often travel at higher speeds and have a large mass due to the presence of a large number of carriages or trucks being hauled by one or more engines, it is difficult for trains and locomotives to stop quickly and suddenly, to avoid a collision. Hence, in circumstances where the rail tracks must cross a road or the like, a crossing control system is generally employed to warn individuals of the presence of a train approaching the crossing. Most crossing control systems typically function to stop the road vehicles at the crossing such that the train or locomotive can proceed through the crossing unimpeded. In most crossing areas an alarm system is employed to warn the drivers or pedestrians in the proximity of the crossing of the approaching train or locomotive, where there is an understanding by the pedestrian or driver of the vehicle that they must stop, in accordance with road safety laws.

In some highly populated areas where trains or locomotives cross roads that carry a large amount of road traffic, boom gates or similar barrier devices are employed to prevent traffic and pedestrians from unknowingly crossing the rail tracks. However in more remote areas such as rural areas, visual and audible alarm systems are typically employed to warn of an approaching train or locomotive. In each instance, the driver of the locomotive or train may have a whistle or similar audible warning device that they may sound when they approach a crossing.

Typically, existing crossing systems, whether they employ a boom gate or barrier or a visual and audible warning system, are configured to sense the presence of a train or locomotive approaching the crossing and to lower boom gates or trigger necessary warning signs to ensure that the train or locomotive have right of way.

Known systems for detecting the presence of a train or locomotive in the area of a crossing have typically employed interlocking or stick relays. Such relays are in the form of circuits that mechanically interlock with each other, with each coil of the interlocking relay being connected to the rails of the track near the crossing, and a track battery is also connected to the rails through a current limiting resistor. As the train or locomotive approaches the crossing, the coils are typically energised and as the train passes over the dedicated region of the track, practically all the current from the track battery is shunted through the train's axles, which shunts the current away from the associated coils, thereby de-energising the coils and sending an appropriate signal to the warning system to warn of the train approaching the crossing. Such conventional detection systems have proven to require a significant amount of wiring and maintenance, together with specialised equipment, and have proven costly to set-up and maintain. Further, the ability to determine the direction of travel of the train and not merely the presence of a train, has not been easily achievable with conventional detection systems, which may be adversely affected by the travelling speed of the train and other such aspects.

More recently, the use of wheel counters and radar sensors have been proposed to detect not only the presence of a train or locomotive approaching a crossing but also the direction of travel of the train. However, such systems are costly to implement and maintain, especially where the crossing is remotely located.

Thus, there is a need to provide a simple and effective means for detecting the presence of a vehicle travelling along a track, that is simple and efficient to employ across a wide variety of applications and which provides reliable use without continual maintenance requirements.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a vehicle detection system for detecting the presence of a vehicle travelling along a path, comprising:
a plurality of sensor elements positioned along a least a portion of said path, each sensor element configured to measure a change in a magnetic field adjacent said sensor element and to transit a signal when a change is measured;
a control unit configured to receive the signal transmitted from each sensor element and to compare the received signals to determine whether the presence of a vehicle has been detected based upon the number of signals received from the sensor elements over a time interval.

In one embodiment, the sensor elements are magnetometer sensors. The magnetometer sensors may be configured to measure data associated with a magnetic field about said sensor and compare that measured data with stored data to determine a change in the magnetic field and to generate a change signal when such a change in magnetic field is measured. The magnetometer sensor may comprise a radio transceiver for transmitting the change signal to the control unit.

The change signal may further include an ID signal to identify the magnetometer sensor transmitting the change signal. The control unit may process the change signals received over a predetermined time and apply a voting system to determine whether the received signals indicate the presence of a vehicle on said path. The voting system may compare the number of change signals received over a given period of time against the total number of sensor elements.

In another embodiment, the control unit may regularly poll the individual sensor elements to determine their state of operation. The control unit may transmit a status signal at regular intervals and request a status signal from each of the sensor elements in response to said status signal.

According to another aspect of the invention, there is provided a method of detecting the presence of a vehicle travelling along a path comprising the steps of:
positioning a predetermined number of sensor elements long a predetermined portion of the path at predetermined intervals, each sensor element being configured to take a reading of a magnetic field present in their immediate proximity and to transmit a signal in accordance with said reading;
receiving one or more transmitted signals from one or more of the predetermined number of sensor elements;
processing the received transmitted signals to identify an active sensor element that transmitted the signal from the predetermined number of sensor elements;
comparing the number of active sensor elements against a number of live sensor elements to determine whether a vehicle is travelling along the path; and
activating a warning system upon determining that a vehicle is travelling along the path.

Each sensor element may comprise a transceiver and a magnetometer to measure the magnetic field in the vicinity of the sensor element and to transmit a signal accordingly. The signal transmitted by the sensor element may indicate a change in the magnetic field present in the immediate vicinity of the sensor element and contains an identification signal embedded therein to identify the sensor element.

The step of receiving the one or more transmitted signal may comprise wirelessly receiving the one or more transmitted signals in a control unit.

The step of processing the transmitted signals may comprise recognising the identification signal embedded within the transmitted signal and recording that signal against the sensor element that transmitted the signal to identify that sensor element as the active sensor element.

The step of comparing the number of active sensor elements against a number of live sensor elements may comprises determining the number of live sensor elements. The live sensor elements may be determined by whether the sensor element responds to a periodic polling signal transmitted by a control unit, thereby indicating that the live sensor element is operational.

The step of determining whether a vehicle is travelling along a path may comprise comparing the number of active sensor elements against the number of live sensor elements and if the number of active sensor elements exceeds a predetermined percentage of the number of live sensor elements the presence of a vehicle is determined. The predetermined percentage may be 35%, or more preferably, may be 50%.

### BRIEF DESCRIPTION OF THE DRAWINGS

The invention may be better understood from the following non-limiting description of preferred embodiments, in which;

FIG. 1 is a perspective view of a conventional level crossing employing the detection system in accordance with an embodiment of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described in relation to the application of the system for use in at a level crossing involving a train and a road vehicle for the purpose of operating a crossing warning signal. However, it will be appreciated that the system of the present invention may be employed across a variety of applications for sensing vehicles and controlling the passage of vehicles for safety and other purposes.

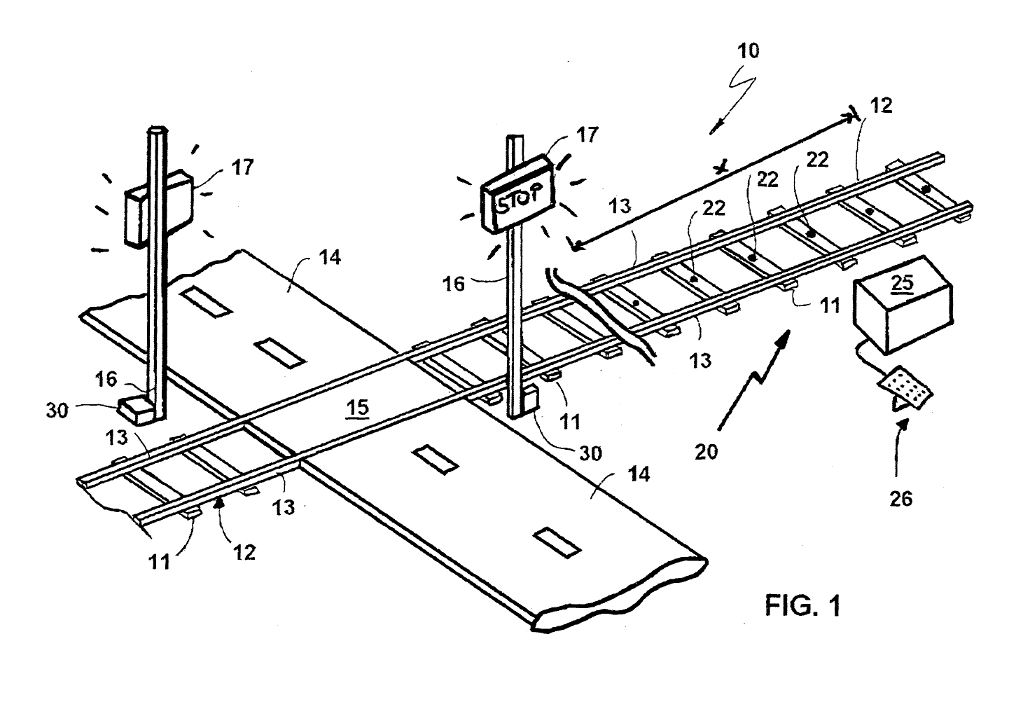

Turning to FIG. 1, a level crossing 10 employing an embodiment of the present invention is shown. The crossing 10 includes a rail track 12 comprising a pair of rails 13 mounted on sleepers 11, which is configured to support a train or locomotive thereon. A road 14 is shown which extends substantially perpendicular to the track 12 such that the track 12 and the road 14 intersect at intersection point 15. The road 14 is shown as a bi-directional single carriage-way; however, the road may be uni-directional or include multiple carriage-ways and still fall within the scope of the present invention.

A warning system 16, in the form of a pair of warning signs are mounted at either sides of intersection 15 to provide a warning signal to drivers, cyclists, motorcyclists and pedestrians travelling along road 14, of an approaching train or locomotive on the track 12. The warning signs are depicted as sign posts bearing a visual warning signal 17 that can be clearly seen by a driver or passenger travelling along road 14. It will be appreciated that the warning system 16 may also include an audible siren as well as a movable barrier, such as a boom gate, as will be appreciated by those skilled in the art.

In order to detect the presence of a train or locomotive travelling along the track 12 so as to trigger the warning system 16, a detection system 20 in accordance with an embodiment the present invention is provided.

The detection system 20 comprises a plurality of sensor elements 22 embedded within sleepers 11 of the track 12, along a dedicated region of the track. In the embodiment as shown, the sensor elements 22 are located in neighbouring sleepers 11, however it will be appreciated that the sensor elements may be positioned in every second or third sleeper 11, or other intervals, along a length of track 12, as will be appreciated by those skilled in the art.

The sensor elements 22 are in the form of magnetometer sensors, capable of measuring the strength and/or direction of a magnetic field. The sensor elements are embedded within a recess formed in the sleepers 11 in a manner which enables the magnetic field immediately above the sleeper to be measured. Each sensor element 22 comprises a ti-axial magnetometer, a microprocessor, a radio transceiver and a power source sufficient to allow operation of the sensor element 22 over a five-ten year period.

In a preferred embodiment as shown, six sensor elements 22 are fitted along the track so as to cover a given length of tack ‘X’. In the embodiment as shown, the so sensor elements 22 are depicted as being located on neighbouring sleepers 11; however, it will be appreciated that distance of separation between the sensor elements 22 may vary. In a preferred form, the length of track to be monitored covers a length of around 80 metres which may be located a distance from the intersection 15 of between 200-1000 metres. Other distances are also envisaged depending on the location of the track.

A control unit 25 is provided adjacent the section ‘X’ of track 12 and generally comprises a housing that houses a microcontroller unit (MCU), a radio transceiver, a power source (such as a battery) and a rechargeable battery source, such as an external solar panel 26 to recharge the battery.

The system 20 operates through ongoing communication between the control unit 25 and each of the sensor elements 22. In this regard, each sensor element 22 is configured to transmit a signal on one channel and to receive a signal on the other channel.

In a preferred embodiment, each sensor element 22 is programmed to ‘wake’ once every one to N seconds. Upon waking, each sensor element 22 communicates with the control unit 25 to receive any signals therefrom, and also performs a sensor function to determine whether there has been a change in the measured magnetic field adjacent that sensor element 22. Each sensor element 22 will be calibrated to have an ambient reading that amounts to a rest state, or a state where there is no change in magnetic field that may be attributed to the presence of a vehicle, such as a train or locomotive. Hence, upon ‘waking’ each sensor element 22 will perform a reading of the magnetic field in its vicinity and compare that reading against the ambient state.

If no change is detected between the measured magnetic field and the ambient state, the sensor element 22 will return to its sleep mode. If a change has been detected, each sensor element 22 will transmit a signal to the control unit 25 indicating a change in state from ambient has occurred. The sensor element will thus continue to transmit such a signal to the control unit 25 every one—N seconds for as long as the change is detected.

Each of the sensor elements 22 will behave in the same manner as discussed above. In order for the control unit 25 to identify the source of the signal received, each sensor element will include a unique ID embedded within the transmitted signal which will be detected by the MCU of the control unit 25.

The control unit 25 will determine the presence of a train on the tracks 12 by a voting system, based on the signals received from each of the six sensor elements 22 located over the dedicated length of track 12. One embodiment of how the voting system may be implemented is as follows:

| No. of Non-Ambient Signals Received from | |
|---|---|
| each sensor elements over a 1 second period | Train Present |
| 1 from 6 | No |
| 2 from 6 | No |
| 3 from 6 | Yes |
| 4 from 6 | Yes |
| 5 from 6 | Yes |
| 6 from 6 | Yes |

In this arrangement, as each sensor element 22 will be conducting a sensing function each second, the control unit is able to receive and process the signals and assess whether the received information indicates the presence of a train each second. As indicated above, if three or more of the sensor elements 22 transmit a signal indicative that the sensed magnetic field for that sensor element 22 has changed from ambient, the control system 25 will consider that a train has entered that region of the track 12 and will transmit a signal to the crossing control unit (CCU) 30.

As is shown in FIG. 1, the CCU 30 may be located at the intersection 15 and may be associated with one or more of the warning systems 16. In such an arrangement, upon receipt of a signal from the control unit 25 indicating that a train has been detected by the sensor elements 22, the CCU 30 initiates the necessary warning device. This may include a flashing sign and appropriate alarm and/or the activation of a boom gate or similar type barrier to close the road 14. The CCU 30 retains the warning system 16 in an active state until it receives a deactivation signal from the control unit 25 or a control unit 25 of another detection system 20 located downstream of the intersection 15. In this regard, it will be appreciated that most intersections 15 will require a detection system positioned at either sides of the intersection 15. In such arrangements a single control system 25 may be used for each different set of sensor elements 22, or separate control systems 25 may be employed.

It will be appreciated that the detection system 20 of the present invention employs a voting system that is able to handle false readings or defective sensor elements 22, without causing the warning systems 16 to be activated unnecessarily. In many existing detection systems, a single defective element of the system will result in the system activating the warning system as a default situation. Such a situation can be considerably disruptive to road traffic flow and is highly undesirable and has the potential to generate significant infrastructure management and maintenance costs.

In the present system 20, in order to constantly monitor the state of the sensor elements 22 during periods of extended inactivity, the control unit 25 is able to poll each sensor element 22. As the sensor elements 22 are configured to only transmit a signal when a change is detected in the sensed magnetic field, the control unit 25 is able to poll each sensor element and control the sequence of signals received from the sensor elements such that each sensor element 22 will have a dedicated time slot into which the signal will be received, which will be determined from the last received signal. Thus, the control unit 25 is able to ‘poll’ each sensor element 22, in accordance with a predetermined order. In a preferred embodiment, the control system 25 is configured to poll the sensor elements 22 once every 10 seconds. As discussed above, upon each sensor element 22 ‘waking’ every second, it checks to see whether it has received a poll request from the control unit 25. If it has received such a poll request, the sensor element 22 provides a response to each poll signal at their directed time interval, by transmitting a ‘health check’ signal that contains the battery state, magnetometer state and the ID number for each sensor element 22.

The control unit 25 is able to analyse the signal to determine the status of each individual sensor element 22 and to determine whether each individual sensor element 22 is in an operational state. If a sensor element 22 does not respond to a poll request or if the received signal indicates low battery status or faulty magnetometer state, the individual sensor element is identified and flagged as not present. The control unit 25 will then report the faulty sensor element 22 to an overall system management body for attention, and advise the CCU accordingly.

Once a sensor element 22 has been flagged as not present, the voting system for determining whether a train is present will also be altered. In the event that one of the sensor elements 22 is detected as faulty, this sensor element will be taken out of assessment and the voting system will be:

| No. of Non-Ambient Signals Received from | |
|---|---|
| each sensor elements over a 1 second period | Train Present |
| 1 from 5 | No |
| 2 from 5 | No |
| 3 from 5 | Yes |
| 4 from 5 | Yes |
| 5 from 5 | Yes |

If two sensor elements 22 fail to respond to a poll or exhibit faulty readings, both sensor elements will be taken out of assessment and the voting system will be:

| No. of Non-Ambient Signals Received from | |
|---|---|
| each sensor elements over a 1 second period | Train Present |
| 1 from 4 | No |
| 2 from 4 | Yes |
| 3 from 4 | Yes |
| 4 from 4 | Yes |

If three or more sensor elements 22 fail to respond to a poll, or exhibit faulty readings, both sensor elements will be taken out of assessment and the detection system will be deemed inoperative and the CCU will be advised accordingly.

The control unit 25 will be in constant communication with the CCU 30, preferably by way of a wireless link. The control unit 25 will be configured to transmit a status signal to the CCU 30 preferably once every 5 seconds. The status signal will preferably include a status of the system and of each individual sensor element 22.

Upon each individual sensor element 22 detecting a change in magnetic field from the ambient state indicative of the presence of a train passing over the sensor element 22, once the train progresses past the sensor element 22, the magnetic field reading taken by the sensor element 22 will return to ambient. When this occurs, the sensor element 22 will perform an internal magnetometer reset and take an appropriate reading to reconfirm that the reading is at ambient. Failure of the individual sensor element 22 returning to ambient measurement will result in the sensor element sending a fault signal to the control unit 25.

Due to the inherent nature of the detection system of the present invention, the direction of travel of the train along the track 12 can be readily determined. As each individual sensor element 22 has its own ID signal, the sequence in which the detection signals are initially received by the control unit 25 can be simply noted and processed to determine the direction of travel.

It will be appreciated that the detection system of the present invention offers a simple means for detecting the presence or otherwise of a train or locomotive travelling along rail tracks. The system employs a chain of sensor elements in the rail tracks that measure a change in magnetic field brought about by a train passing over each of the sensor elements. Such a system merely transmits a detected change in each sensor element which can be wirelessly transmitted to a control unit and processed accordingly, without the need for dedicated circuitry and equipment and significant cabling, which is both costly and requires constant maintenance.

In this regard, the present invention offers a simple system that employs a self diagnostic system to regularly check on the health of the sensors and the processing system to ensure that faulty components are detected and do not interfere with the analysis of the signal processing. Such an arrangement ensures that a faulty sensor will not set of the warning system by default, and by employing a voting system to process the individual sensor element signals, safety and effective operation of the detection system is enhanced.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the system uppermost.

It will be appreciated by those skilled in the art that many modifications and variations may be made to the methods of the invention described herein without departing from the spirit and scope of the invention.

1-18. (canceled)

19. A vehicle detection system for detecting the presence of a vehicle travelling along a path, said system comprising:
a plurality of sensor elements positioned along at least a portion of said path, each sensor element configured to measure a change in a magnetic field adjacent said sensor element and to transmit a signal when a change is measured; and
a control unit configured to receive the signal transmitted from each sensor element and to compare the received signals to determine whether the presence of a vehicle has been detected based upon the number of signals received from the sensor elements over a time interval.

20. A vehicle detection system according to claim 19, wherein the sensor elements are magnetometer sensors.

21. A vehicle detection system according to claim 20, wherein the magnetometer sensors are configured to:
measure data associated with a magnetic field about said senor and compare that measured data with stored data to determine a change in the magnetic field; and
generate a change signal when such a change in magnetic field is measured.

22. A vehicle detection system according to claim 21, wherein the magnetometer sensor comprises a radio transceiver for transmitting the change signal to the control unit.

23. A vehicle detection system according to claim 22, wherein the change signal further includes an ID signal to identify the magnetometer sensor transmitting the change signal.

24. A vehicle detection system according to claim 23, wherein the control unit processes the change signals received over a predetermined time and applies a voting system to determine whether the received signals indicate the presence of a vehicle on said path.

25. A vehicle detection system according to claim 24, wherein the voting system compares the number of change signals received over a given period of time against the total number of sensor elements.

26. A method of detecting the presence of a vehicle travelling along a path, said method comprising the steps of:
positioning a predetermined number of sensor elements long a predetermined portion of the path at predetermined intervals, each sensor element being configured to take a reading of a magnetic field present in their immediate proximity and to transmit a signal in accordance with said reading;
receiving one or more transmitted signals from one or more of the predetermined number of sensor elements;
processing the received transmitted signals to identify an active sensor element that transmitted the signal from the predetermined number of sensor elements;
comparing the number of active sensor elements against a number of live sensor elements to determine whether a vehicle is travelling along the path; and
activating a warning system upon determining that a vehicle is travelling along the path.

27. A method according to claim 26, wherein each sensor element comprises a transceiver and a magnetometer to measure the magnetic field in the vicinity of the sensor element and to transmit a signal accordingly.

28. A method according to claim 27, wherein the signal transmitted by the sensor element indicates a change in the magnetic field present in the immediate vicinity of the sensor element and contains an identification signal embedded therein to identify the sensor element.

29. A method according to claim 26, wherein the step of receiving the one or more transmitted signal comprises wirelessly receiving the one or more transmitted signals in a control unit.

30. A method according to claim 28, wherein the step of processing the transmitted signals comprises recognising the identification signal embedded within the transmitted signal and recording that signal against the sensor element that transmitted the signal to identify that sensor element as the active sensor element.

31. A method according to claim 30, wherein the step of comparing the number of active sensor elements against a number of live sensor elements comprises determining the number of live sensor elements.

32. A method according to claim 31, wherein the live sensor elements are determined by whether the sensor element responds to a periodic polling signal transmitted by a control unit, thereby indicating that the live sensor element is operational.

33. A method according to claim 32, the step of determining whether a vehicle is travelling along a path comprises comparing the number of active sensor elements against the number of live sensor elements and if the number of active sensor elements exceeds a predetermined percentage of the number of live sensor elements the presence of a vehicle is determined.

34. A method according to claim 33, wherein the predetermined percentage is 35%.

35. A method according to claim 33, wherein the predetermined percentage may vary depending upon the number of live sensor elements detected.

36. A method according to claim 26, wherein the step of activating a warning system upon determining that a vehicle is travelling along the path comprises activating any one or more of a visual alarm, audible alarm or a barrier.
